(19) United States
(12) Patent Application Publication
(10) Pub. No.: US 2025/0392173 A1
(43) Pub. Date: Dec. 25, 2025

(54) STATOR FOR AN ELECTRICAL MACHINE HAVING A RESILIENT OUTER CONTOUR

(71) Applicant: ZF FRIEDRICHSHAFEN AG, Friedrichshafen (DE)

(72) Inventors: Reinhard DEPPERT, Gochsheim (DE); Christoph KIESER, Schwarzach am Main (DE)

(21) Appl. No.: 18/877,658

(22) PCT Filed: Jun. 26, 2023
(86) PCT No.: PCT/EP2023/067271

§ 371 Date: Dec. 20, 2024

(30) Foreign Application Priority Data
Jun. 27, 2022 (DE) 10 2022 206 448.8

(51) Int. Cl. H02K 1/16; H02K 1/20

(52) U.S. Cl. CPC H02K 1/16; H02K 1/20

(57) ABSTRACT

A stator lamination for a stator of a rotating electric machine. The stator lamination has a yoke region with a radially inner edge and a radially outer edge, and a plurality of first recesses is arranged in an outer area of the yoke region along the radially outer edge. A first recess has a radially outer limit with a curvature aligned with the radially outer edge, and webs are formed between the first recesses and the radially outer edge, which webs are elastically deformable in radial direction and provide a spring action for cooperating with a mounting surface of a stator housing.

### CROSS REFERENCE TO RELATED APPLICATIONS

This is a U.S. national stage of Application No. PCT/EP2023/067271 filed Jun. 26, 2023. Priority is claimed on German Application No. DE 10 2022 206 448.8 filed Jun. 27, 2022 the content of which is incorporated herein by reference.

### BACKGROUND OF THE INVENTION

### 1. Field of the Invention

The disclosure is directed to a stator lamination for a stator of a rotating electric machine, a stator, an electric machine, and a motor vehicle outfitted with an electric machine.

### 2. Description of the Related Art

There is currently a sharp increase in the use of electric drives in motor vehicles, whether as hybrid drives combined with an internal combustion engine or as all-electric drives. Such electric machines commonly have a rotor and a stator. In an inrunner machine, the stator is arranged inside of a housing that outwardly surrounds the stator and is supported by this housing. These machine housings are generally produced from an aluminum material in order to gain a weight advantage. A force reaction, i.e., a supporting force or a supporting torque, acting between the stator and the housing during operation of the machine is substantially based on a press fit of the join partners and is highly temperature-dependent. Accordingly, the useful temperature range for reliable operation of the electric machine is comparatively narrow. On the other hand, motor vehicles should be designed in such a way that they can be utilized in a reliably operating manner within a comparatively broad temperature range. The temperature band extends from −40° C. to +85° C., increasingly also between −45° C. and +90° C. The force reaction at the lower temperature limit can be increased threefold compared with the upper temperature limit. Accordingly, at the lower temperature limit, the housing can deform and, at the upper temperature limit, the stator of the machine cannot muster the required supporting torque and will rotate, i.e., slip, relative to the housing. Very large congruences between the lamination stack of the stator, which comprises steel material, and the housing are required for the reliable transmission of torque under all operating conditions. The large congruence between the stator and the housing and the different thermal expansion coefficients brings about high mechanical stresses in the components. The housing must be highly heated during assembly. There is a risk of fretting. Further, the rigid coupling between the stator and housing that is produced by the interference fit facilitates the transmission of vibrations and sound from the electric machine to the drive unit.

### SUMMARY OF THE INVENTION

A goal of one aspect of the invention is to provide a solution by which the above-mentioned force reaction change within the usual temperature band can be reduced or the temperature band in which the electric machine can operate can be increased.

One aspect of the invention is a stator lamination, a stator, a corresponding electric machine, and a corresponding motor vehicle.

A stator lamination for a stator of a rotating electric machine is suggested. A stator lamination has:
a yoke region with a radially inner edge and a radially outer edge, and in which
a plurality of first recesses is arranged in an outer area of the yoke region along the radially outer edge,
the first recesses have a radially outer limit with a curvature aligned with the radially outer edge, and webs are formed between the first recesses and the radially outer edge, which webs are elastically deformable in radial direction for cooperating with a mounting surface of a stator housing and provide a spring action.

An electric machine within the meaning of the invention can be a generator for electrical energy and an electric drive that converts electrical energy into rotational energy in order to drive a motor vehicle, for example. In particular, an electric machine within the meaning of the invention has a rotor on the inside and a stator on the outside.

Within the meaning of one aspect of the invention, recesses may be holes, cutouts, boreholes and the like in the stator lamination. The webs of the stator laminations which are resilient in radial direction are tensioned when installed in a stator housing. Accordingly, a resilience distributed radially and substantially uniformly along the circumference acts between the stator laminations, or a stator made therefrom, and the stator housing. This resilience acts across the entire operating temperature range and can at least partially compensate a decreasing mutual contact pressing force that occurs as a result of the differing thermal expansion of the stator lamination stack and stator housing. This has the advantage that the temperature dependence of the supporting force or the force reaction of the stator during operation of the electric machine can be reduced. In other words, the characteristic curve of the force reaction with respect to temperature can be flatter in this way. In particular, a radial component of the supporting force can be advantageously influenced in this way. Accordingly, as a result, the machine can be reliably operated over a larger temperature range and over a larger torque range.

A stator lamination within the meaning of one aspect of the invention refers to a thin, circular disk of electrical lamination steel, which can be formed of one or more parts. When a plurality of such stator laminations are axially stacked along a central axis of the stator or along the axis of symmetry of the machine, an annular stator lamination stack results. The stator lamination stack is provided for installation in a stator housing.

In the suggested stator lamination, the radially outer edge can advantageously be formed in particular with a continuously extending contour in an undulating, e.g., sinusoidal, shape, an outer recess or outside recess being formed in each instance in circumferential direction between two first recesses. This results in arcuate webs, particularly convex webs, with a greater effective length compared to the outer circular edge of the stator lamination. This means that the effective deformation region of the stator lamination opposite a stator housing is increased. In particular, an effective overall length of the webs can exceed the circumferential length of the stator lamination as a result of the plurality of deformable webs at the circumference.

In order to achieve a softness or elasticity that is distributed as homogeneously as possible in circumferential direction, it is further advantageous that the webs can have a substantially constant width in the area of the extension of the first recesses.

A further improvement in the supporting behavior of a stator lamination in the installed state can be achieved in that second recesses are provided in the outer area of the yoke region radially inwardly of the first recesses, elastically deformable webs being formed between the first recesses and the second recesses.

A further aspect according to one aspect of the invention relates to a stator for an electric machine with a plurality of stacked stator laminations. A stator lamination can be arranged within the stator lamination stack at an offset in circumferential direction relative to an axially adjacent stator lamination for a uniform distribution of the resilience generated by the webs in a stator housing. The stator can comprise stacks of stator laminations, which are rotated relative to one another in circumferential direction and which do not overlap congruently, but the stator laminations within a stack can be stacked congruently.

Particularly as it relates to a utilization of the stator as drive source of a vehicle, a stator housing and the stator lamination stack are dimensioned in such a way and joined to one another in such a way that the webs of the stator laminations which contact the stator housing are elastically tensioned relative to the stator housing within the entire operating temperature range, particularly between −45° C. and +90° C. Accordingly, a sufficiently high supporting force can be provided for the reaction torque of the electric machine over the entire intended operating range.

Yet another aspect of one aspect of the invention relates to an electric machine with a stator according to the invention. The invention is further also directed to a motor vehicle having an electric machine according to the invention. This has the advantage that a motor vehicle can be provided in which the electric machine can be reliably and efficiently operated in the predefined operating temperature range and/or the operating temperature range of the motor vehicle can be increased.

Further advantages will be apparent from the following description, drawings and patent claims.

### BRIEF DESCRIPTION OF THE DRAWINGS

The accompanying exemplary figures will be described in the following. The drawings show:

FIG. 1A is a stator lamination;

FIG. 1B is a stator lamination;

FIG. 2 is a stator lamination;

FIG. 3 is a stator lamination;

FIG. 4 is a stator; and

FIGS. 5A,B are two views of an electric machine with a stator.

### DETAILED DESCRIPTION OF THE PRESENTLY PREFERRED EMBODIMENTS

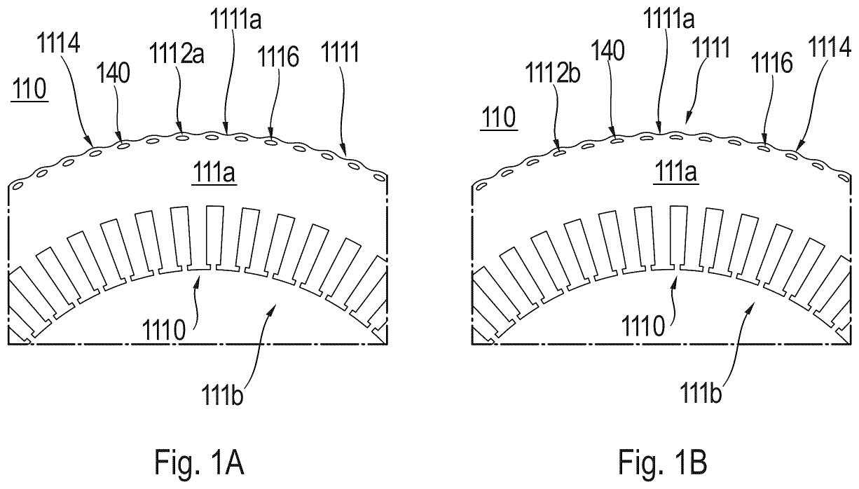

FIGS. 1a, b show examples of a stator lamination 110 according to one aspect of the invention, which is shaped annularly in particular but which is shown only in section. Alternatively, a stator lamination 110 can be formed from a plurality of circular segments which are joined together. The metal stator lamination 110 has a yoke region 111a and a tooth region 111b with a plurality of stator teeth which protrude radially inwardly from the yoke region 111a. The stator lamination 110 has a radially inner edge 1110 and a radially outer edge 1111. The radially outer edge 1111 is larger than the radially inner edge 1110. The radially outer edge 1111 is intended to cooperate with a cylindrical inner circumferential surface of a housing of an electric machine.

Further, the stator lamination 110 has a plurality of first recesses 1112 in the yoke region 111a. The recesses 1112 are arranged so as to be uniformly spaced in an outer area of the yoke region 111a along the radially outer edge 1111. A first recess 1112 has a radially outer limit 1116 with a curvature aligned with the radially outer edge 1111. Webs 1114 which are at least partially elastically deformable and, in particular, deformable in radial direction are formed radially between the recesses 1112 and the radially outer edge 1111. Due to the geometric structure of the webs 1114, these webs 1114 are suitable to provide a spring action, preferably at the radially outer edge of the stator lamination 110. The pressing diameter of outside recesses 1111a is discontinuous at the radially outer circumference 1111 of the stator lamination 110 such that, in this location, it comprises just arcuate, in particular convexly shaped, webs 1114.

These outside recesses at the radially outer circumference 1111 may be optional. Alternatively, the outer circumference 1111 can also be formed as a circular line. A radial softness acting uniformly at the circumference is produced as a result of the large quantity of recesses 1112 and associated webs 1114. On the one hand, the radial softness facilitates the assembly of the stator in the machine housing and, on the other hand, ensures the reliable torque support of the stator over a larger operating temperature range.

In FIG. 1a, the first recesses 1112a are formed elliptically. The larger main axis of an ellipse is oriented in circumferential direction of a stator lamination. Alternatively, a circular shape is also possible. In FIG. 1b, the first recesses 1112b are arcuate or kidney-shaped. The webs 1114 in both embodiments have a substantially constant radial extension or width in the area of the extension of the first recesses 1112a, b.

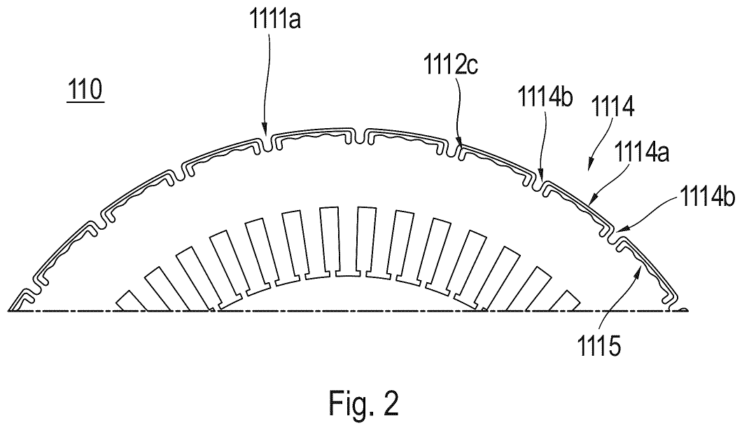

FIG. 2 shows a further exemplary embodiment of a stator lamination 110 according to one aspect of the invention which is again shown only in section. In the stator lamination in FIG. 2, the first recesses 1112c have an arcuate portion formed in circumferential direction and two substantially straight-line portions extending in radial direction. Accordingly, the recesses 1112c as a whole are formed to be approximately U-shaped. Consequently, the webs 1114 formed at the circumference have a portion 1114a formed in circumferential direction and two substantially radially extending portions 1114b. A radially inner limit 1115 of the recesses 1112c is undulating so that the web portion 1114a can possibly contact the latter during a deformation.

The first recesses 1112 which are shown in FIGS. 1a, b; 2 can have a larger circumference-to-surface ratio compared with an elliptical shape so that, as a result of the webs 1114 adjoining the first recesses 1112, a better spring action is achievable for supporting in a machine housing.

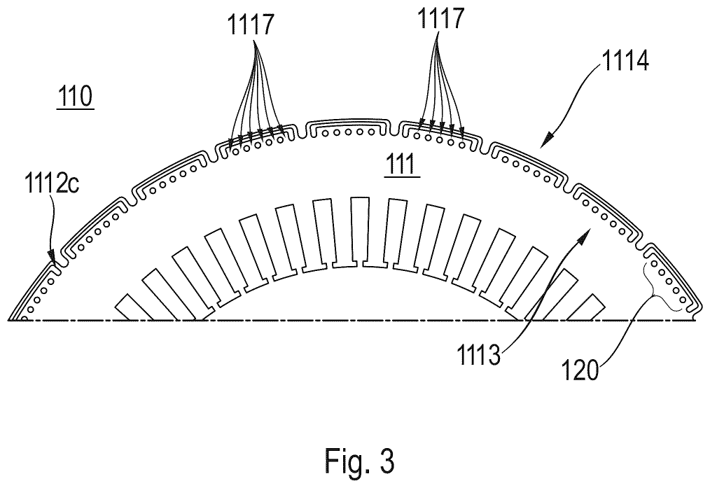

FIG. 3 shows an example of a stator lamination 110 according to one aspect of the invention which is essentially based on that shown in FIG. 2. The stator lamination 110 has a plurality of further, second recesses 1113 in the yoke region 111. The recesses 1113 are arranged so as to be uniformly spaced in the yoke region 111 radially inwardly of the plurality of recesses 1112c in an outer area of the yoke region 111. The recesses 1113 are formed in this instance to be circular, for example, and accordingly have at least one rounded portion. The recesses 1113 are limited in circumferential direction and radially outwardly by, in particular, elastically deformable webs 1117, which further increases the spring action mentioned above. The plurality of second recesses 1113 is divided into sets of recesses 120. A recess set 120 has at least two second recesses 1113. Preferably, a center of a longitudinal axis of a recess set is arranged vertical to a center of a longitudinal side of a corresponding recess 1112 of the plurality of recesses 1112c.

Further, the yoke region 111 is again formed in an undulating manner at a side of a recess set 120 that faces the corresponding recess 1112c so as to follow the surface of the respective second recesses 1113 of the recess set 120 and projects into the respective recess 1112c.

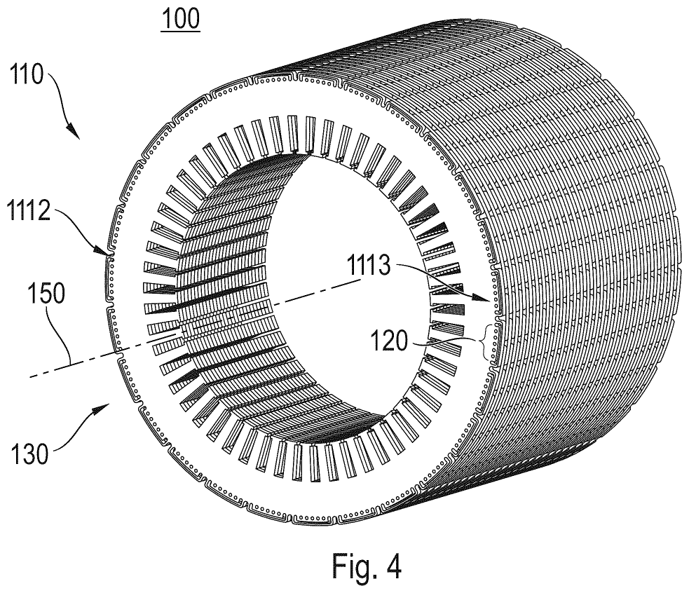

FIG. 4 shows a stator 100 according to one aspect of the invention. The stator 100 has a plurality of stator laminations 110 according to the invention which are stacked along a center axis of the stator 100 and form a stator lamination stack 130. The stator laminations 110 shown in the example in FIG. 4 are identical to those in FIG. 3. Stator laminations 110 form an interference fit assembly. The negative effects of the thermal expansion on the interference fit can be positively affected by the radial spring action of a stator lamination 110. The stator laminations 110 are arranged successively along the stator axis and accordingly form the interference fit assembly.

A stator lamination 110 is arranged within the stator lamination stack 130 so as to be offset in circumferential direction relative to an axially adjacent stator lamination 110, i.e., the stator laminations 110 are arranged without being in register with one another.

In particular, a stator lamination 110 is arranged to be offset relative to the respective adjacent stator lamination 110 by a whole number multiple of a length of a second recess 1113 of a recess set 120 in such a way that a recess 1112 of a stator lamination 110 contacts in each instance two first recesses 1112 of a respective adjacent stator lamination 110. A second recess 1113 of a stator lamination 110 is arranged to be offset relative to a second recess 1113 of the respective adjacent stator lamination 110 in such a way that a second recess 1113 of a stator lamination 110 only partially overlaps with a second recess 1113 of the respective adjacent stator lamination 110. Further, a closure element 112 can be provided which covers an outer stator lamination 110.

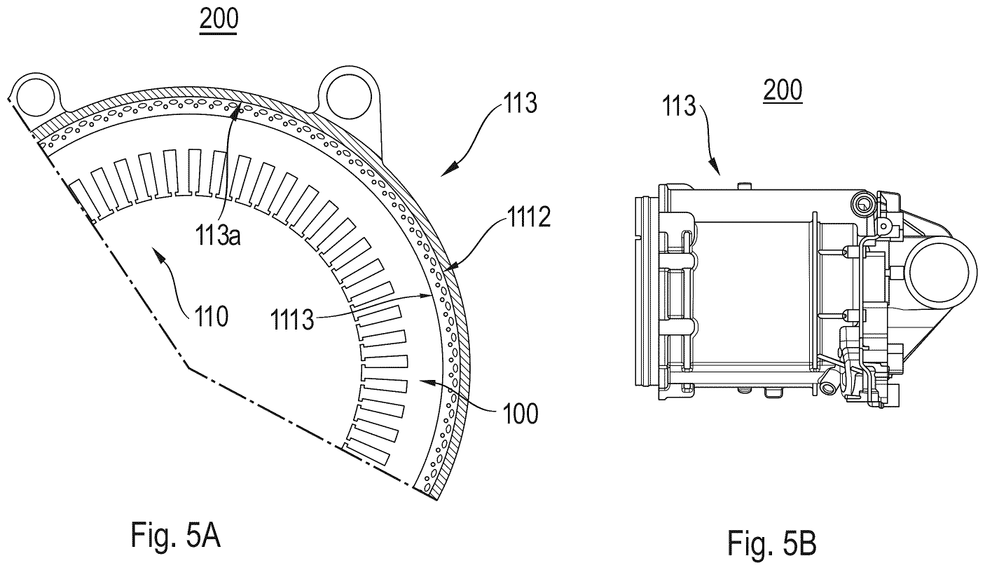

FIG. 5 shows an electric machine 200 according to one aspect of the invention. FIG. 5a shows a section of the electric machine 200 in cross section and FIG. 5b shows a section of the electric machine 200 in longitudinal section. Only the stator 100 and the housing 113 are shown.

The stator in FIG. 5 has a cylindrical stator housing 113 with an inner mounting surface 113a for arranging the stator 100. A stator lamination 110 contacts the stator housing 113 substantially only vertically at a transverse axis of the center of the longitudinal side of the corresponding recess 1112 of the plurality of recesses 1112. The larger thermal expansion of the aluminum housing is compensated by the deformation taking place during the installation of the stator 100 into the stator housing 1113 with respect to the webs 1114 of the stator laminations 110 which were mentioned above referring to FIGS. 1-3. Further, a partial vibration decoupling can be achieved between the interference fit assembly and housing.

The axial channels of the stator 100 formed by the recesses 1112 serve at the same time as cooling channels in fluid-cooled electric machines 200.

Basically, two embodiments are to be distinguished as regards the size and shape of the recesses 1112.

The radially smallest envelope circle diameter resulting from a recess 1112 is greater than or equal to the pressing diameter of the stator housing 113. This results in an improved connection between the stator 100 and housing 113 with respect to thermal engineering, since the stator 100 contacts the housing borehole virtually over the entire surface after the stator 100 is mounted.

Alternatively, the radially smallest envelope circle diameter resulting from the recess 1112 is smaller than the pressing diameter of the stator housing 113. This results in additional cooling channels, a poorer direct thermal connection, but an improved decoupling of vibrations.

To improve the cooling arrangement and increase the supporting force of the stator 100 in the stator housing 113, second recesses 1113 can be inserted radially inwardly of the first recesses 1112. In this respect, it is advantageous when the additional inner row of cooling passages is arranged opposite the first valley-forming recess 1112. The arcuate structures can be distributed over the circumference, possibly in a geometrically varying manner. In this regard, it is advantageous when the pitch of the arcuate elements in fluid-cooled electric machines 200 is a multiple of the stamping-related lamination rotation. If the axial throughflow of fluid through the outer region of the stator 100 is to be throttled or prevented in particular embodiments of the electric machine 200, this can be produced by an irregular multiple between the arc pitch of the stamping-related lamination rotation.

A further solution for this consists in closing the axial channels with an unperforated end lamination or closing with elastomeric closure stoppers.

In order to visually monitor the correct lamination rotation during the assembly process, one or more arcuate elements can be formed asymmetrically or identified by notches.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-9. (canceled)

10. A stator lamination for a stator of a rotating electric machine, comprising:
a yoke region with a radially inner edge and a radially outer edge;
a plurality of first recesses arranged in an outer area of the yoke region along the radially outer edge;
each first recess having a radially outer limit with a curvature aligned with the radially outer edge; and
webs formed between each first recesses and the radially outer edge, the webs are elastically deformable in radial direction for cooperating with a mounting surface of a stator housing and provide a spring action.

11. The stator lamination according to claim 10, wherein the radially outer edge is formed in an undulating manner, and an outside recess is formed in each instance in circumferential direction between two first recesses.

12. The stator lamination according to claim 10, wherein the webs have a substantially constant width in an area of an extension of the first recesses.

13. The stator lamination according to claim 10, wherein second recesses are provided in an outer area of the yoke region radially inwardly of the first recesses, wherein elastically deformable webs are formed between the first recesses and the second recesses.

14. A stator for an electric machine comprising:
a plurality of stator laminations, comprising:
a yoke region with a radially inner edge and a radially outer edge;
a plurality of first recesses arranged in an outer area of the yoke region along the radially outer edge;
each first recess having a radially outer limit with a curvature aligned with the radially outer edge; and
webs formed between each first recess and the radially outer edge, the webs are elastically deformable in radial direction for cooperating with a mounting surface of a stator housing and provide a spring action,
wherein the plurality of stator laminations are axially stacked along a central axis of the stator and form a stator lamination stack.

15. The stator according to claim 14, wherein a stator lamination is arranged inside of the stator lamination stack at an offset in circumferential direction relative to an axially adjacent stator lamination, without being arranged in register with one another.

16. The stator according to claim 14, further comprising:
a stator housing, wherein the stator lamination stack is joined to the stator housing such that the webs of the stator laminations which contact the stator housing are elastically tensioned relative to the stator housing within an entire operating temperature range.

17. The stator according to claim 16, wherein the operating temperature range is between −45° C. and +90° C.

18. An electric machine, comprising:
a stator comprising:
a plurality of stator laminations, comprising:
a yoke region with a radially inner edge and a radially outer edge;
a plurality of first recesses arranged in an outer area of the yoke region along the radially outer edge;
each first recess having a radially outer limit with a curvature aligned with the radially outer edge; and
webs formed between each first recess and the radially outer edge, the webs are elastically deformable in radial direction for cooperating with a mounting surface of a stator housing and provide a spring action,
wherein the plurality of stator laminations are axially stacked along a central axis of the stator and form a stator lamination stack.

19. A motor vehicle comprising:
an electric machine comprising:
a stator comprising:
a plurality of stator laminations, comprising:
a yoke region with a radially inner edge and a radially outer edge;
a plurality of first recesses arranged in an outer area of the yoke region along the radially outer edge;
a first recess having a radially outer limit with a curvature aligned with the radially outer edge; and
webs formed between the first recesses and the radially outer edge, the webs are elastically deformable in radial direction for cooperating with a mounting surface of a stator housing and provide a spring action,
wherein the plurality of stator laminations are axially stacked along a central axis of the stator and form a stator lamination stack.
